(19) United States
(12) Patent Application Publication
(10) Pub. No.: US 2009/0238301 A1
(43) Pub. Date: Sep. 24, 2009

(54) MULTILEVEL SIGNAL RECEIVER

(75) Inventor: Tszshing Cheung, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/407,621

(22) Filed: Mar. 19, 2009

(30) Foreign Application Priority Data
Mar. 19, 2008 (JP) 2008-072138

(51) Int. Cl. H04L 25/34; H04L 25/49

(52) U.S. Cl. 375/291; 375/286; 375/290

(57) ABSTRACT

In the present multilevel signal receiver, an output signal of a comparator which judges a high-level of a multilevel signal and a signal obtained by inverting an output signal of a comparator which judges a low-level of the multilevel signal are input to an edge-triggered RS-FF, and an output signal of the edge-triggered RS-FF is fed back to the comparator on the high-level side via a LPF, so that a high-level threshold voltage is regulated. At the same time, a signal obtained by inverting the output signal of the comparator on the high-level side and the output signal of the comparator on the low-level side are input to an edge-triggered RS-FF, and an output signal of the edge-triggered RS-FF is fed back to the comparator on the low-level side via a LPF, so that a low-level threshold voltage is regulated. As a result, it becomes possible to provide a multilevel signal receiver of a simple circuit configuration, capable of controlling the thresholds used for level judgment of the multilevel signal of three or more levels to follow in real time a level change in the multilevel signal.

### CROSS-REFERENCE TO RELATED APPLICATION

This application is based upon and claims the benefit of priority of the prior Japanese Patent Application No. 2008-072138, filed on Mar. 19, 2008, the entire contents of which are incorporated herein by reference.

### FIELD

The present invention relates to a multilevel signal receiver for receiving a multilevel signal amplitude modulated into three or more levels to convert it to a binary signal, and in particular, to a technology for controlling thresholds used for level judgment of the multilevel signal.

### BACKGROUND

As illustrated in a block diagram of FIG. 24 for example, an apparatus used in the 100 Gbps Ethernet® comprises an interface circuit which mutually connects, by means of a plurality of electric pathways 104, a framer 101 inputting and outputting a 6.25 Gbps parallel signal of 16 channels, with a serializer (SER) 102 and a deserializer (DES) 103 each connected to an optical transmission path through which a 100 Gbps optical signal is propagated. In this interface circuit, the 6.25 Gbps parallel signal of 16 channels input to the framer 101 is multiplexed in accordance with a required frame format to become a 25 Gbps parallel signal of 4 channels. Then, the 25 Gbps parallel signal is converted to a 100 Gbps serial signal by the serializer 102, so that a 100 Gbps optical signal modulated in accordance with the 100 Gbps serial signal is output to the optical transmission path. Further, the 100 Gbps optical signal input from the optical transmission path is converted to an electric signal by an optical receiver (not illustrated in the figure), and thereafter, is converted to a 25 Gbps parallel signal of 4 channels by the deserializer 103 to be further converted to a 6.25 Gbps parallel signal of 16 channels by the framer 101.

As an encoding format of 25 Gbps parallel signal which is transmitted/received by the interface circuit of the 100 Gbps Ethernet as described above, it is possible to use a NRZ (Non-Return to Zero) format. However, there is a drawback in that a signal of NRZ format is hard to correspond to a transmission speed higher than 40 Gbps due to waveform degradation caused by bandwidth restriction on the electric pathways (channels). Therefore, in recent years, as a transmission technology for realizing a higher interface circuit, there has been discussed a transmission system using a multilevel signal of three or more levels, such as a duo-binary signal, a four-level pulse-amplitude modulation (PAM4) signal, a partial response (PR4) signal or the like. For example, in the OIF (Optical Internetworking Forum), there have been initiated discussions relating to the standardization of multilevel signal transmitting/receiving circuit for the 100 Gbps Ethernet.

For the transmission system using such a multilevel signal of three or more levels, a transmitter 210 and a receiver 230 each of which has a configuration as illustrated in FIG. 25 are typically used. The transmitter 210 comprises a pre-coder 211 and an encoder 212. The pre-coder 211 has a function of simplifying a decoder on the reception side to avoid erroneous propagation, and the encoder 212 has a function of converting a binary input signal to a multilevel signal (here, a signal having three levels). The three-level signal output from the encoder 212 is propagated through an electric pathway 220 to be received by the receiver 230. The receiver 230 comprises two comparators 231 and 232, and a decoder 233. The comparator 231 is input with the three-level signal propagated through the electric pathway 220 at one of input terminals thereof, to judge a level of the three-level signal on the basis of a high level threshold voltage Vhigh supplied to the other input terminal thereof. Further, the comparator 232 is input with the three-level signal propagated through the electric pathway 220 at one of input terminals thereof, to judge the level of the three-level signal on the basis of a low level threshold voltage Vlow supplied to the other input terminal thereof. The decoder 233 converts the three-level signal to a binary output signal based on the judgment results in the comparators 231 and 232.

In such a configuration of the receiver 230, the threshold voltages Vhigh and Vlow acting as the bases for the level judgment of the input signal are fixed at previously set values on the bases of respective levels of the multilevel signal at the transmitting time and signal attenuation in the electric pathway 220. Therefore, if the set values of the threshold voltages Vhigh and Vlow are improper, an error occurs in the binary output signal.

As a conventional technology for avoiding the above described error at the reception processing time, there is a receiver 230′ applying a feedforward configuration as illustrated in FIG. 26 for example. In this receiver 230′ a part of the received three-level signal is supplied to a power detector 234 to thereby detect the power of the three-level signal, and an output signal of the power detector 234 indicating the detection result is averaged by a low-pass filter (LPF) 235 to be supplied to two level shifters 236 and 237. Then, in each of the level shifters 236 and 237, an output level of the LPF 235 is shifted by a required amount in accordance with an external signal, so that the high level threshold voltage Vhigh and the low level threshold voltage Vlow are generated to be supplied to the comparators 231 and 232. As a result, as illustrated in signal waveforms on an upper stage of FIG. 27, the threshold voltages Vhigh and Vlow are regulated according to a state of the practically received three-level signal, thereby avoiding an error during the level judgment. Incidentally, a lower stage of FIG. 27 exemplarily illustrates changes in a voltage level Vo at the transmitting time of the three-level signal and a voltage level Vin at the receiving time thereof, and a change in the reception signal power Pin detected by the power detector 234.

Further, for a receiver corresponding to a binary signal, which is different from that for the multilevel signal of three or more levels, there has been disclosed a technology for automatically controlling a decision level according to level variations of a reception signal (refer to Japanese Laid-open Patent Publication No. 2002-141956). In this conventional technology, a high level variation of the reception signal and a low level variation thereof are monitored using a plurality of decision circuits (for example, three decision circuits), so that the decision level is automatically controlled at an optimum value based on whether or not outputs of the decision circuits of which decision levels are adjacent to each other in small and large order among the decision circuits are coincident with each other.

However, the conventional receiver as illustrated in FIG. 26 which feedforward controls the threshold voltages is not configured to follow in real time level changes depending on a code pattern of the reception signal to thereby optimize the threshold voltages used during the level judgment. Therefore, there is a problem in that the level judgment cannot be performed with high precision, as the signal speed becomes higher or the signal levels are increased. Namely, voltage values of respective levels (for example, a high-level, a O-level and a low-level in the three-level signal or the like) of the multilevel signal input to the receiver are attenuated from those at the transmitting time due to the bandwidth restriction on the electric pathway, and further, are changed in real time depending on in what code pattern the respective levels appear. However, to such changes, it is practically hard to optimize the threshold voltages by the feedforward control in accordance with the external signal.

Further, in the case where the automatic control technology for the decision levels disclosed in the above Japanese Laid-open Patent Publication No. 2002-141956 is applied to the multilevel signal of three or more levels, since it becomes necessary to monitor the variations of the respective levels using the decision circuits more than the number of levels of the multilevel signal, there is a problem in that a large scale circuit of large power consumption should be applied as the receiver.

### SUMMARY

According to one aspect of the invention, a multilevel signal receiver which is input with a multilevel signal amplitude modulated into three or more levels, judges levels of the input signal using at least two thresholds and outputs a signal converted into binary in accordance with the level judgment results, includes: first and second judging sections; first and second feedback control sections; and a converting section. The first judging section is input with the multilevel signal and a signal indicating a first threshold, and judges whether or not the levels of the multilevel signal are higher than the first threshold, to output a signal of which level is changed in accordance with the judgment result. The second judging section is input with the multilevel signal and a signal indicating a second threshold of which level is lower than that of the first threshold, and judges whether or not the levels of the multilevel signal are lower than the second threshold, to output a signal of which level is changed in accordance with the judgment result. The first feedback control section uses the output signal of the first judging section and a signal obtained by inverting the output signal of the second judging section, and, according to appearance timing of leading edges of the respective signals, regulates the level of the first threshold supplied to the first judging section. The second feedback control section uses the output signal of the second judging section and a signal obtained by inverting the output signal of the first judging section, and according to appearance timing of leading edges of the respective signals, regulates the level of the second threshold supplied to the second judging section. The converting section outputs a binary signal converted from the multilevel signal, in accordance with the output signals of the first and second judging sections.

According to the multilevel signal receiver as described above, first and second threshold voltages used for the level judgment of the multilevel signal are feedback controlled based on combinations of the output signals of the first and second judging sections, so as to follow in real time level changes depending on a code pattern of the multilevel signal. Therefore, the level judgment of the multilevel signal can be performed with high precision, and it becomes possible to output the binary signal obtained by precisely decoding the multilevel signal. Further, in the multilevel signal receiver, since the first and second feedback control sections can be configured by simple circuits as described later, it is possible to realize reception characteristics at low power consumption and also in stable to variations of temperature or the like.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a block diagram showing a configuration of a first embodiment of the multilevel signal receiver;

FIG. 2 is a block diagram showing a configuration example of a decoder in the first embodiment;

FIG. 3 is a block diagram showing another configuration example of the decoder in the first embodiment;

FIG. 4 is a diagram showing a truth table of an edge-triggered RS-FF in the first embodiment;

FIG. 5 is a block diagram showing a configuration example of a pre-coder in a transmitter of FIG. 1;

FIG. 6 is a block diagram showing a configuration example of an encoder in the transmitter of FIG. 1;

FIG. 7 is a diagram for explaining an operation of the first embodiment;

FIG. 8 is a block diagram showing a configuration of a second embodiment of the multilevel signal receiver;

FIG. 9 is a diagram showing one example of eye patterns of a four-level signal transmitted/received in the second embodiment;

FIG. 10 is a diagram showing a configuration of a decoder in the second embodiment;

FIG. 11 is a diagram showing a truth table of an edge-triggered RS-FF in the second embodiment;

FIG. 12 is a diagram showing a configuration example of a transmitter in FIG. 8;

FIG. 13 is a diagram showing another configuration example of the transmitter in FIG. 8;

FIG. 14 is a diagram for explaining an operation of the second embodiment;

FIG. 15 is a diagram for explaining changes of voltage levels V(i), V(j) and V(k) in the second embodiment;

FIG. 16 is a block diagram showing a configuration of a third embodiment of the multilevel signal receiver;

FIG. 17 is a diagram showing a truth table of an edge-triggered RS-FF in the third embodiment;

FIG. 18 is a block diagram showing a configuration of a fourth embodiment of the multilevel signal receiver;

FIG. 19 is a block diagram showing a configuration of a fifth embodiment of the multilevel signal receiver;

FIG. 20 is a block diagram showing a configuration of a sixth embodiment of the multilevel signal receiver;

FIG. 21 is a diagram for explaining an operation of the sixth embodiment;

FIG. 22 is a diagram showing one example in which the multilevel signal receiver is applied to a server network;

FIG. 23 is a diagram showing one example in which the multilevel signal receiver is applied to a LAN;

FIG. 24 is a diagram illustrating one example of an apparatus used for the 100 Gbps Ethernet;

FIG. 25 is a diagram illustrating configuration examples of typical transmitter and receiver used for the three-level signal transmission;

FIG. 26 is a diagram illustrating a configuration example of a conventional receiver to which a feedforward configuration is applied; and

FIG. 27 is a diagram for explaining an operation of the receiver in FIG. 26.

### DESCRIPTION OF EMBODIMENTS

Hereinafter, embodiments of the invention will be described with reference to drawings. The same reference numerals denote the same or equivalent parts in all drawings.

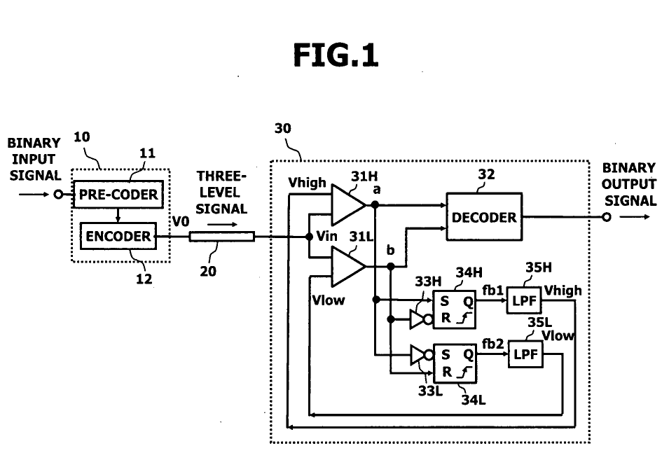

FIG. 1 is a block diagram showing a configuration of a first embodiment of a multilevel signal receiver.

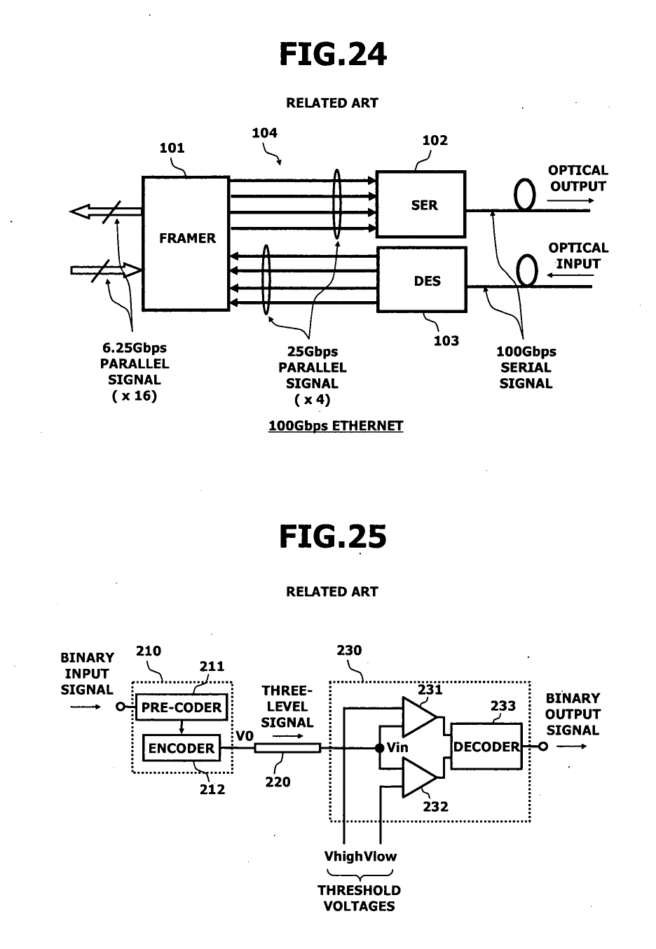

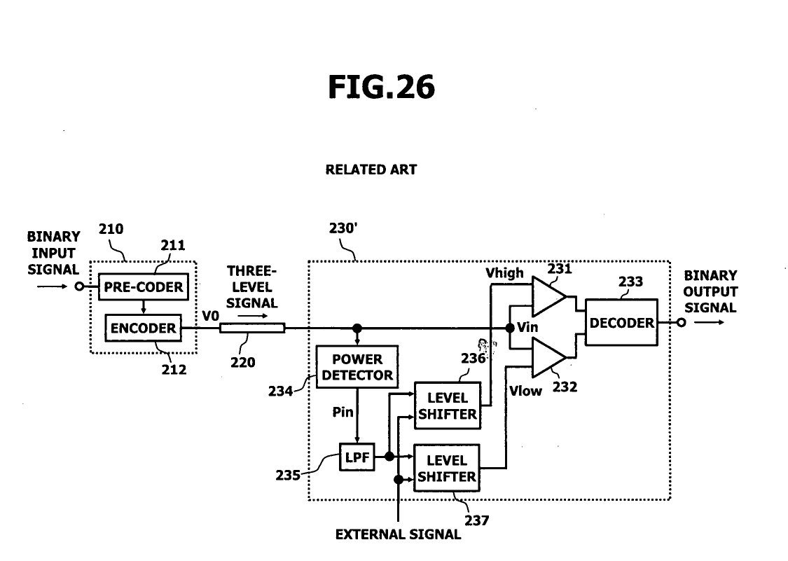

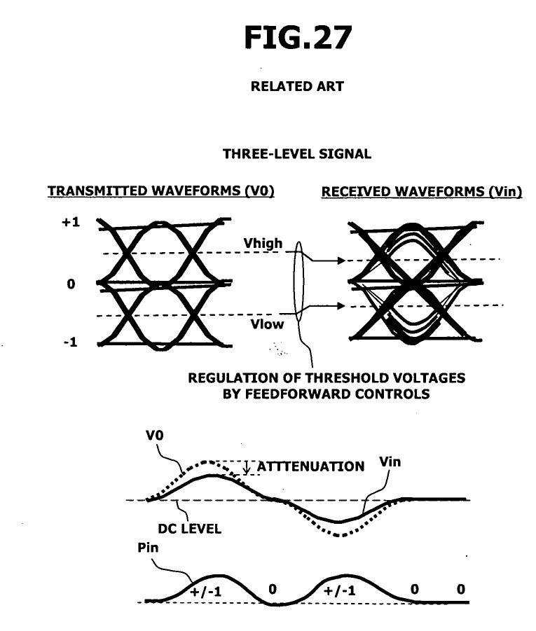

In FIG. 1, a multilevel signal receiver 30 in the present embodiment is used as a receiver which receives a multilevel signal propagated through each electric pathway to convert it to a binary signal, in an interface circuit (high-speed link) provided in the 100 Gbps Ethernet as illustrated in FIG. 24. Herein, one example is shown in which a three-level signal of high-level, 0-level and low-level (for example, a duo-binary signal or the like) transmitted from a required transmitter 10 disposed on the transmission side of the interface circuit is propagated through an electric pathway 20 to be subjected to bandwidth restriction, and thereafter, is input to the receiver 30 to be reception processed.

To be specific, the receiver 30 in the present embodiment includes for example: two comparators 31H and 31L as first and second judging sections; a decoder 32 as a converting section; two inverters (inverting circuits) 33H and 33L as first and second feedback control sections; two edge-triggered RS flip-flops (to be referred to as RS-FF, hereunder) 34H and 34L; and two low-pass filters (LPF) 35H and 35L.

The comparator 31H is supplied with the three-level signal propagated through the electric pathway 20 at one of input terminals thereof, and is applied with a high level threshold voltage Vhigh output from the LPF 35H at the other input terminal thereof. An output signal of the comparator 31H is input to the decoder 32. At the same time, a part thereof is branched to be supplied to an input terminal on the set (S) side of the edge-triggered RS-FF 34H, and also, to an input terminal on the set (S) side of the edge-triggered RS-FF 34L after inverted by the inverter 33L. Further, the comparator 31L is supplied with the three-level signal propagated through the electric pathway 20 at one of input terminals thereof, and is applied with a low level threshold voltage Vlow output from the LPF 35L at the other input terminal thereof. An output signal of the comparator 31L is input to the decoder 32. At the same time, a part thereof is branched to be supplied to an input terminal on the reset R side of the edge-triggered RS-FF 34L, and also, to an input terminal on the reset (R) side of the edge-triggered RS-FF 34H after inverted by the inverter 33H.

Incidentally, herein, a voltage level of the three-level signal input to the respective comparators 31H and 31L is Vin, and output ends of the comparators 31H and 31L are nodes “a” and “b”.

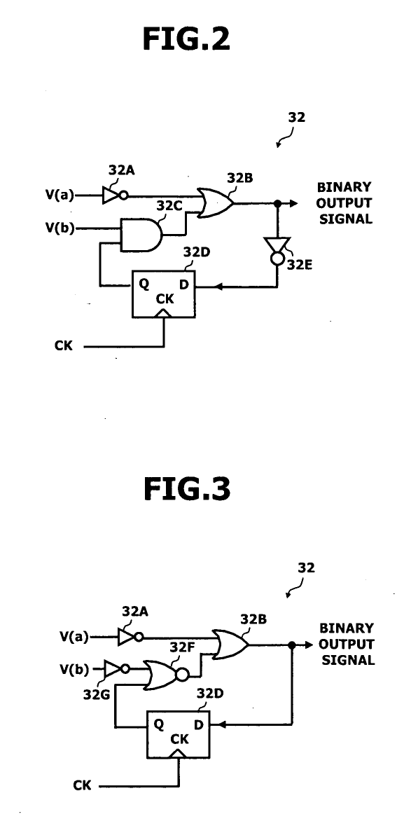

The decoder 32 converts the three-level signal to a binary signal based on judgment results in the comparators 31H and 31L to externally output the binary signal. The decoder 32 can be realized by combining logic gates as shown in FIG. 2 and FIG. 3 for example, and may be implemented in a discrete circuit or an integrated circuit (for example, a LSI or a FPGA (Field Programmable Gate Array)) using a CMOS or a bipolar process. To be specific, in a configuration example of FIG. 2, an output voltage V(a) of the comparator 31H is applied on one of input terminals of an OR gate 32B via an inverter 32A, and an output voltage V(b) of the comparator 31L is applied on one of input terminals of an AND gate 32C. To the other input terminal of the AND gate 32C, an output signal of a D flip-flop (to be referred to as D-FF, hereunder) 32D is input, and an output signal of the AND gate 32C is supplied to the other input terminal of the OR gate 32B. To a data input terminal of the D-FF 32D, an output signal of the OR gate 32B is input via an inverter 32E. Thus, a binary signal converted from the three-level signal is output from the OR gate 32B. Further, a configuration example of FIG. 3 uses a NOR gate 32F in place of the AND gate 32C in FIG. 2, and differs from the circuit configuration of FIG. 2 in that the output voltage V(b) of the comparator 31L is supplied to one of input terminals of the NOR gate 32F via an inverter 32G and the output signal of the OR gate 32B is directly input to the data input terminal of the D-FF 32D.

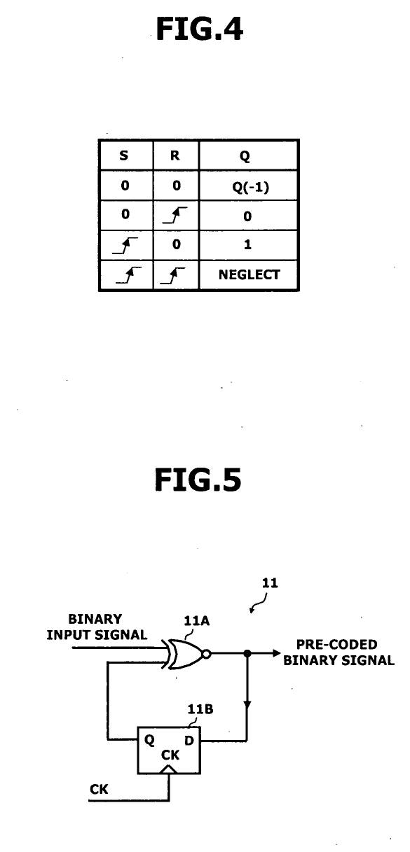

In each of the edge-triggered RS-FFs 34H and 34L (FIG. 1), a logic level of a signal output from an output terminal (Q) thereof is changed in accordance with a truth table shown in FIG. 4, according to a leading edge of the signal input to each input terminal on the set and reset sides. Here, an output end of the edge-triggered RS-FF 34H is a node “fb1” and an output end of the edge-triggered RS-FF 34L is a node “fb2”. Incidentally, an arrow line in the truth table of FIG. 4 expresses the leading edge of the input signal, and Q(−1) indicates a logic value of the output signal before the input signal is level changed.

The LPF 35H integrates (averages) the output signals of the edge-triggered RS-FF 34H to generate a signal indicating the high level threshold voltage Vhigh, and outputs it to the comparator 31H. Further, the LPF 35L integrates (averages) the output signals of the edge-triggered RS-FF 34L to generate a signal indicating the low level threshold voltage Vlow, and outputs it to the comparator 31L.

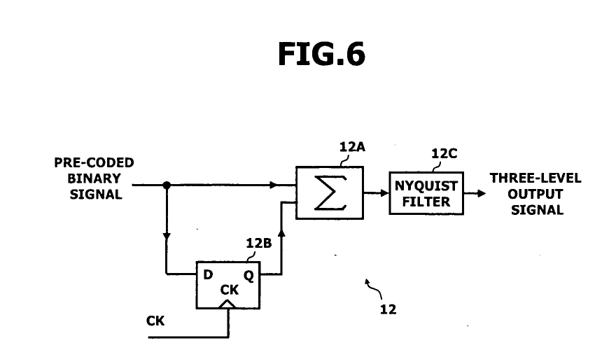

Here, there will be additionally described in brief the three-level signal transmitter 10 shown on the left side in FIG. 1. The transmitter 10 comprises for example: a pre-coder 11 which is supplied with a binary input signal from outside; and an encoder 12 which is input with an output signal of the pre-coder 11. The pre-coder 11 can be realized by combining a coincidence circuit 11A and a D-FF 11B as shown in FIG. 5 for example, and the encoder 12 can be realized by combining a summation circuit 12A, a D-FF 12B and a Nyquist filter 12C as shown in FIG. 6 for example. By disposing the pre-coder 11 as described above in the transmitter 10, a configuration of the decoder 32 in the receiver 30 can be simplified, and also, it becomes possible to avoid error propagation.

Next, there will be described an operation of the receiver 30 in the first embodiment.

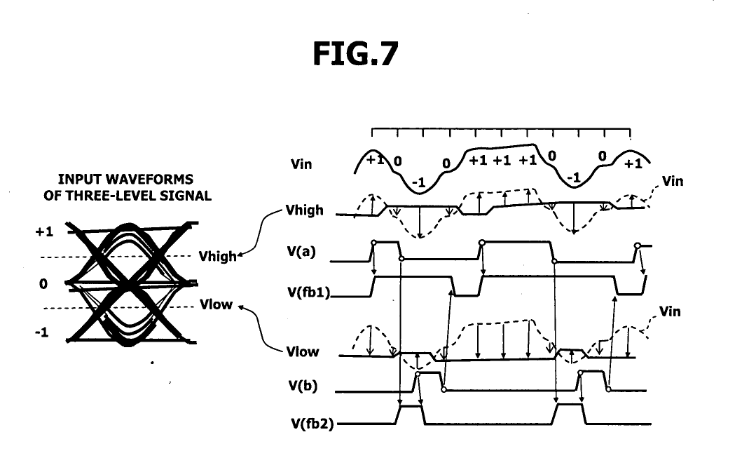

In the receiver 30 of the above configuration, when the three-level signal having eye patters as shown on the left side of FIG. 7 for example and a time change of the voltage level Vin thereof showing a waveform as shown in a first stage on the right side of FIG. 7, is input to each of the comparators 31H and 31L, then in the comparator 31H, the voltage level Vin of the three-level signal is compared with the high level threshold voltage Vhigh shown in a second stage on the right side of FIG. 7, so that a signal of which voltage level V(a) is changed in a waveform as shown in a third stage on the right side of FIG. 7 is output from the comparator 31H. Further, in the comparator 31L, the voltage level Vin of the three-level signal is compared with the low level threshold voltage Vlow shown in a fifth stage on the right side of FIG. 7, so that a signal of which voltage level V(b) is changed in a waveform as shown in a sixth stage on the right side of FIG. 7 is output from the comparator 31L.

Then, in the edge-triggered RS-FF 34H which is supplied with the output signal of the comparator 31H at the input terminal on the set side, and also, is supplied with the signal obtained by inverting the output signal of the comparator 31L by the inverter 33H at the input terminal on the reset side, a signal of which voltage level V(fb1) is changed in a waveform as shown in a fourth stage on the right side of FIG. 7 is generated in accordance with the truth table of FIG. 4, according to appearance timing of the leading edge of each input signal. Further, also in the edge-triggered RS-FF 34L which is supplied with the signal obtained by inverting the output signal of the comparator 31H by the inverter 33L at the input terminal on the set side, and also, is supplied with the output signal of the comparator 31L at the input terminal on the reset side, a signal of which voltage level V(fb2) is changed in a waveform as shown in a seventh stage on the right side of FIG. 7 is generated in accordance with the truth table of FIG. 4, according to appearance timing of the leading edge of each input signal.

The signals generated in the edge-triggered RS-FFs 34H and 34L respectively pass through the LPFs 35H and 35L to be subjected to integration processing. As a result, the high level threshold voltage Vhigh shown in the second stage on the right side of FIG. 7 and the low level threshold voltage Vlow shown in the fifth stage on the right side of FIG. 7, each of which follows in real time the change in the voltage level Vin of the input signal depending on a code pattern, are generated, so that the high level threshold voltage Vhigh is applied on the comparator 31H, and also, the low level threshold voltage Vlow is applied on the comparator 31L.

In the comparators 31H and 31L, level judgment of the input signals is performed with high precision on the bases of the high level threshold voltage Vhigh and the low level threshold voltage Vlow, so that signals indicating the judgment results are input to the decoder 32, and as a result, the binary output signal obtained by precisely decoding the three-level signal is generated.

It is important that feedback controls of the high level threshold voltage Vhigh and the low level threshold voltage Vlow using the output signals of the comparators 31H and 31L in the receiver 30 described above are performed at high speeds according to a bit rate of the three-level signal. For the feedback controls, in the duo-binary signal for example, there are characteristics in that {+1, 0,+1} and {−1, 0, −1} do not exist as series of code change, and therefore, it is possible to sufficiently realize the high speed feedback controls capable of corresponding to 100 Gbps or the like.

As described in the above, according to the receiver 30 in the first embodiment, the regulation of the threshold voltages used for the level judgment of the three-level signal is realized by the feedback controls of simple configurations using a dual analog circuit block. Therefore, it is possible to reduce a possibility that reception characteristics are varied by an influence of manufacturing process, temperature or the like, and it is also possible to reduce the power consumption. Further, differently from a conventional feedforward control, since the threshold voltages can be automatically regulated in real time without the necessity of an external signal, it becomes possible to extend a noise margin (a voltage difference between the input signal and the threshold) in the level judgment of the input signal. Furthermore, since the configuration is such that the threshold voltages are optimized by the feedback controls, it is possible to realize the more stable reception characteristics relative to the temperature variation.

Next, there will be described a second embodiment of the multilevel signal receiver.

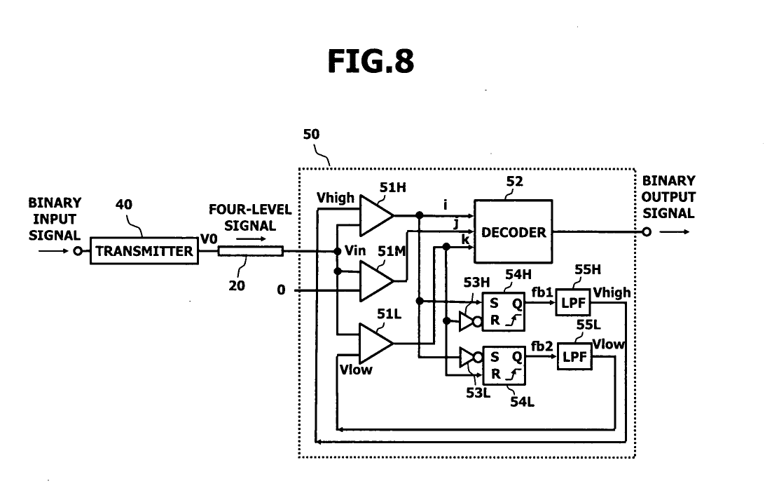

FIG. 8 is a block diagram showing a configuration of a multilevel signal receiver in the second embodiment.

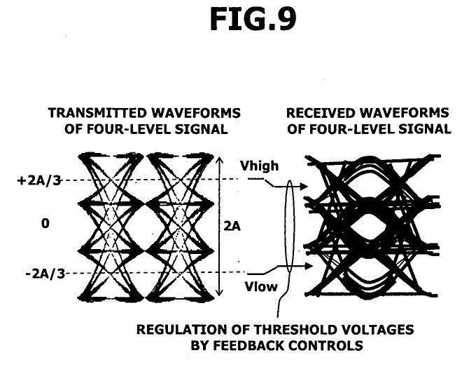

In FIG. 8, a multilevel signal receiver 50 in the present embodiment is used as a receiver which receives a multilevel signal propagated through each electric pathway to convert it to a binary signal, in an interface circuit (high-speed link) provided in the 100 Gbps Ethernet as illustrated in FIG. 24. Herein, one example is shown in which a four-level signal (for example, PAM4, PR4 or the like) transmitted from a required transmitter 40 disposed on the transmission side of the interface circuit is propagated through the electric pathway 20 to be subjected to bandwidth restriction, and thereafter, is input to the receiver 50 to be reception processed. FIG. 9 shows one example of eye patterns of the transmitted/received four-level signal. In this example, the maximum voltage amplitude of the four-level signal at the transmitting time is 2 A and a center level of amplitude is O[V]. In this case, four levels of the transmitted signal are A[V], A/3[V], −A/3[V] and −A[V], and intermediate voltage levels of the respective levels of the transmitted signal are +2 A/3[V], 0[V] and −2 A/3[V].

To be specific, the receiver 50 includes for example: three comparators 51H, 51L and 51M as first to third judging sections; a decoder 52 as a converting section; two inverters 53H and 53L as first and second feedback control sections; two edge-triggered RS flip-flops (RS-FF) 54H and 54L; and two low-pass filters (LPF) 55H and 55L.

The comparator 51H is supplied with the four-level signal propagated through the electric pathway 20 at one of input terminals thereof, and is applied with a high level threshold voltage Vhigh output from the LPF 55H at the other terminal thereof. An output signal of the comparator 51H is input to the decoder 52. At the same time, a part thereof is branched to be supplied to an input terminal on the set (S) side of the edge-triggered RS-FF 54H, and also, to an input terminal on the set (S) side of the edge-triggered RS-FF 54L after inverted by the inverter 53L. Further, the comparator 51M is supplied with the four-level signal propagated through the electric pathway 20 at one of input terminals thereof, and is applied with a ground voltage (0[V]) at the other input terminal thereof. An output signal of the comparator 51M is input to the decoder 52. Furthermore, the comparator 51L is supplied with the four-level signal propagated through the electric pathway 20 at one of input terminals thereof, and is applied with a low level threshold voltage Vlow output from the LPF 55L at the other input terminal thereof. An output signal of the comparator 51L is input to the decoder 52. At the same time, a part thereof is branched to be supplied to an input terminal on the reset (R) side of the edge-triggered RS-FF 44L, and also, to an input terminal on the reset (R) side of the edge-triggered RS-FF 54H after inverted by the inverter 53H.

Incidentally, herein, a voltage level of the four-level signal input to the respective comparators 51H, 51M and 51L is Vin, and output ends of the comparators 51H, 51M and 51L are nodes “i”; “j” and “k”.

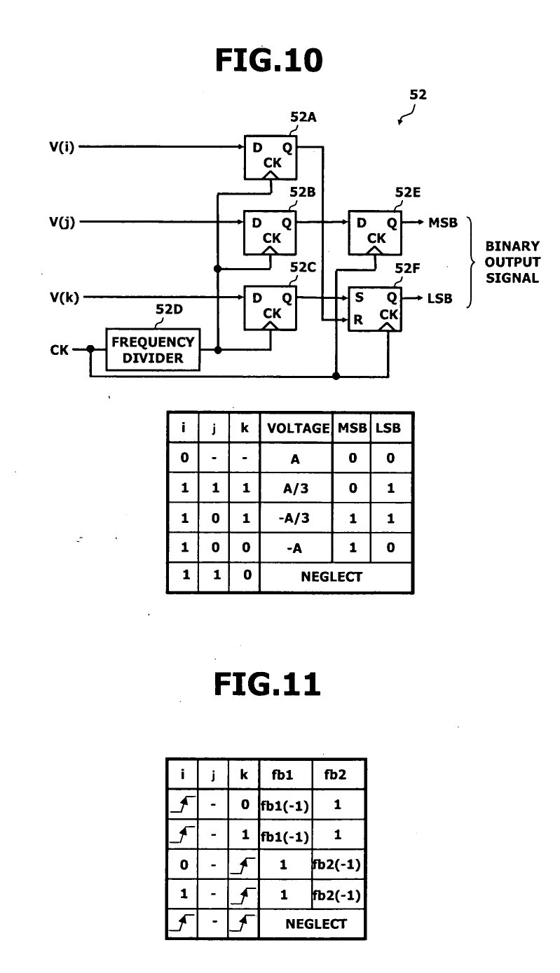

The decoder 52 converts the four-level signal to a binary signal based on judgment results in the comparators 51H, 51M and 51L to externally output the binary signal. The decoder 52 can be realized by combining logic gates as shown in FIG. 10 for example. To be specific, in a configuration example of FIG. 10, output voltages V(i), V(j) and V(k) of the comparators 51H, 51M and 51L are applied respectively on D-FFs 52A, 52B and 52C. To the D-FFs 52A, 52B and 52C, signals each obtained by dividing a clock signal CK into ½ times by a frequency divider 52D are supplied to clock input terminals thereof. An output signal of the D-FF 52A is supplied to a reset input terminal of a RS-FF 52F, an output signal of the D-FF 52B is supplied to a data input terminal of a D-FF 52E, and an output signal of the D-FF 52C is input to a set input terminal of the RS-FF 52F. The D-FF 52E and the RS-FF 52F each is supplied with the clock signal CK at a clock input terminal thereof, so that a voltage level of an output signal thereof is changed in accordance with a logic table shown on the lower side of FIG. 10, according to a voltage level of the input signal. As a result, a binary signal of two bits in which the output signal of the D-FF 52E has a most significant bit (MSB) and the output signal of the RS-FF 52F has a least significant bit (LSB), is output.

In each of the edge-triggered RS-FFs 54H and 54L (FIG. 8), a logic level of a signal output from an output terminal (Q) thereof is changed in accordance with a truth table shown in FIG. 11, according to a leading edge of the signal input to each input terminal on the set and reset sides. Here, an output end of the edge-triggered RS-FF 54H is a node “fb1” and an output end of the edge-triggered RS-FF 54L is a node “fb2”. Incidentally, an arrow line in the truth table of FIG. 11 expresses the leading edge of the input signal. Further, fb1(−1) and fb2(−1) indicate logic values of the output signals before the input signal is level changed

The LPF 55H integrates (averages) the output signals from the edge-triggered RS-FF 54H to generate a signal indicating the high level threshold voltage Vhigh, and outputs the signal to the comparator 51H. Further, the LPF 55L integrates (averages) the output signals from the edge-triggered RS-FF 54L to generate a signal indicating the low level threshold voltage Vlow, and outputs the signal to the comparator 51L.

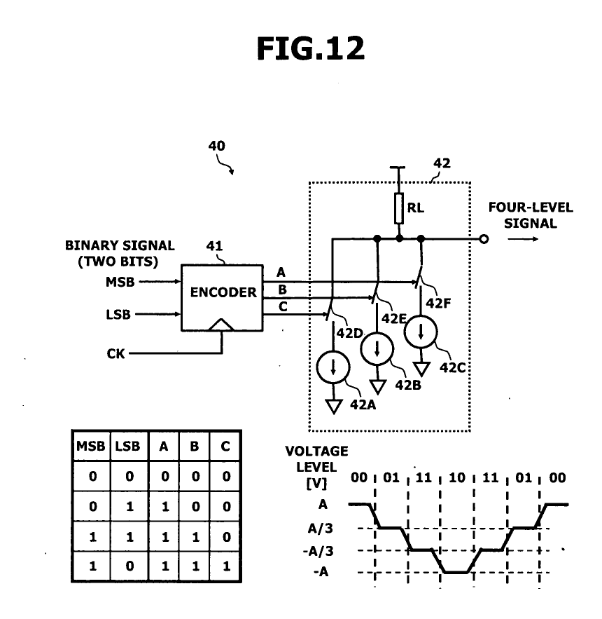

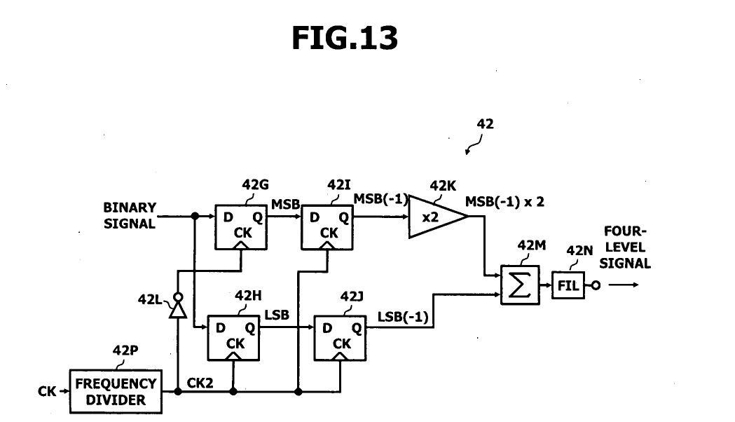

Here, there will be additionally described in brief the four-level signal transmitter 40 shown in the left side in FIG. 8. The transmitter 40 can be realized by combining an encoder 41 and a driver 42 as shown in FIG. 12 for example. The encoder 41 is input with the binary signal of two bits and the clock signal CK, and values A, B and C of three output signals thereof are changed in accordance with a truth table shown in the lower left side of FIG. 12. The driver 42 includes three electric current sources 42A, 42B and 42C, and switches 42D, 42E and 42F, and outputs the four-level signal of which voltage level is changed as shown in the lower right side of FIG. 12 when the switches 42D, 42E and 42F are turned on/off in accordance with the output signals A, B and C from the encoder 41. Further, the transmitter 40 can be realized by combining a coincidence circuit, D-FFs 42G, 42H, 42I and 42I, an amplifier 42K, an inverter 42L, a summation circuit 42M, a Nyquist filter (FIL) 42N and a frequency divider 42P, as shown in FIG. 13. In this configuration example, the binary signal is input to data input terminals of the D-FFs 42G and 42H, and output signals MSB and LSB of the D-FFs 42G and 42H are supplied to data input terminals of the D-FFs 42I and 42I. To clock input terminals of the D-FFs 42H, 42I and 42I, signals CK2 each obtained by dividing the clock signal CK into ½ times by the frequency divider 42P are supplied, and to a clock input terminal of the D-FF 42G, a signal obtained by inverting the clock signal CK2 by the inverter 42L is supplied. An output signal MSB(−1) of the D-FF 42I is amplified by the amplifier 42 to two times, and thereafter, is supplied to the summation circuit 42. Further, an output signal LSB(−1) of the D-FF 42I is directly supplied to the summation circuit 42M. Then, an output signal of the summation circuit 42M passes through the Nyquist filter 42N, so that the four-level signal is output.

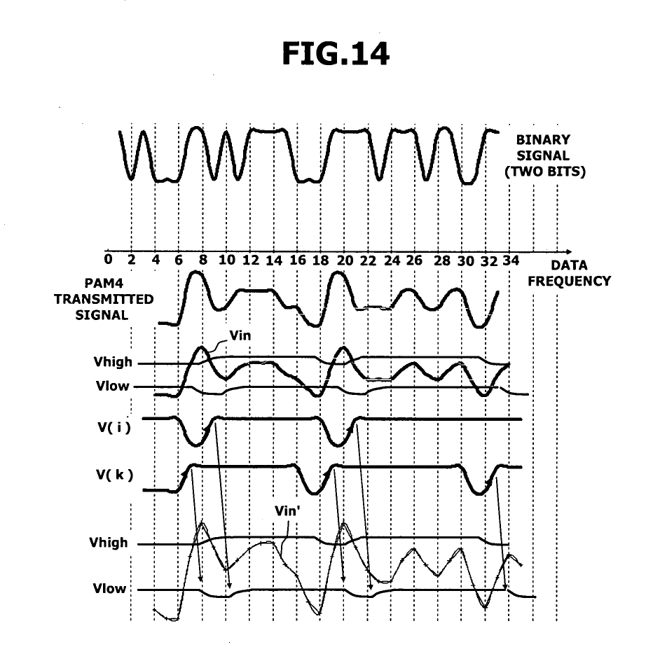

In the receiver 50 of the above configuration, among the three threshold voltages used for the level judgment of the four-level signal, the high level threshold voltage Vhigh and the low level threshold voltage Vlow are feedback controlled by the dual system analog circuit similar to that in the first embodiment, to thereby follow in real time the change in the voltage level Vin of the input signal depending on the code pattern. FIG. 14 is a diagram showing one example of signal waveforms of the PAM4 transmitted from the transmitter 40 and showing signal waveforms at respective portions corresponding thereto in the receiver 50. A first stage of FIG. 14 indicates the binary signal of two bits input to the transmitter 40, and in accordance with the binary signal, the PAM4 signal as shown in a second stage of FIG. 14 is transmitted to the electric pathway 20 from the transmitter 40. The PAM4 signal propagated through the electric pathway 20 is input to the comparators 51H, 51M and 51L of the receiver 50 in a waveform Vin as shown in a third stage of FIG. 14, to be compared with the threshold voltages of high-level, O-level and low-level. As a result, a signal of which voltage level (i) is changed in a waveform as shown in a fourth stage of FIG. 14 is output from the comparator 51H, and also, a signal of which voltage level V(k) is changed in a waveform as shown in a fifth stage of FIG. 14 is output from the comparator 51L. Then, the output signals of the comparators 51H and 51L are supplied respectively to the edge-triggered RS-FFs 54H and 54L, and output levels of the edge-triggered RS-FFs 54H and 54L are changed in accordance with the truth table of FIG. 11, and further, output signals of the edge-triggered RS-FFs 54H and 54L respectively pass through the LPFs 55H and 55L, so that the high level threshold voltage Vhigh and the low level threshold voltage Vlow as shown in the fifth stage of FIG. 14, each of which follows in real time the change depending on the code pattern of the voltage level Vin of the input signal, are generated. Incidentally, a signal waveform Vin′ in the fifth stage of FIG. 14 indicates the PAM4 signal of which bandwidth is narrowed. As a result, in the comparators 51H and 51L, the level judgment of the input signal is performed with high precision on the bases of the high level and low level threshold voltages as described above, and the signals indicating the judgment results are input to the decoder 52, so that the binary output signal obtained by precisely decoding the four-level signal is generated.

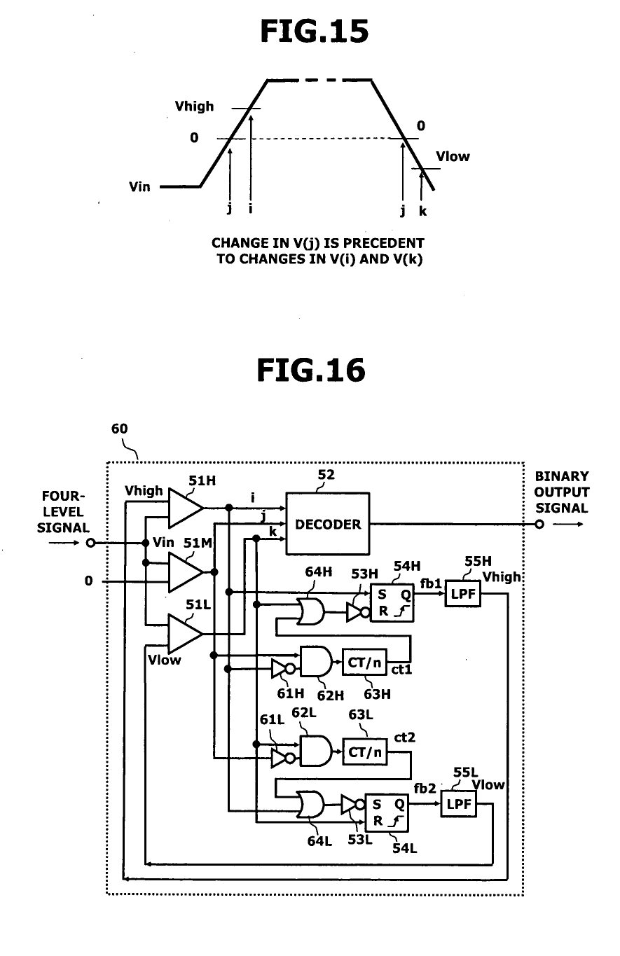

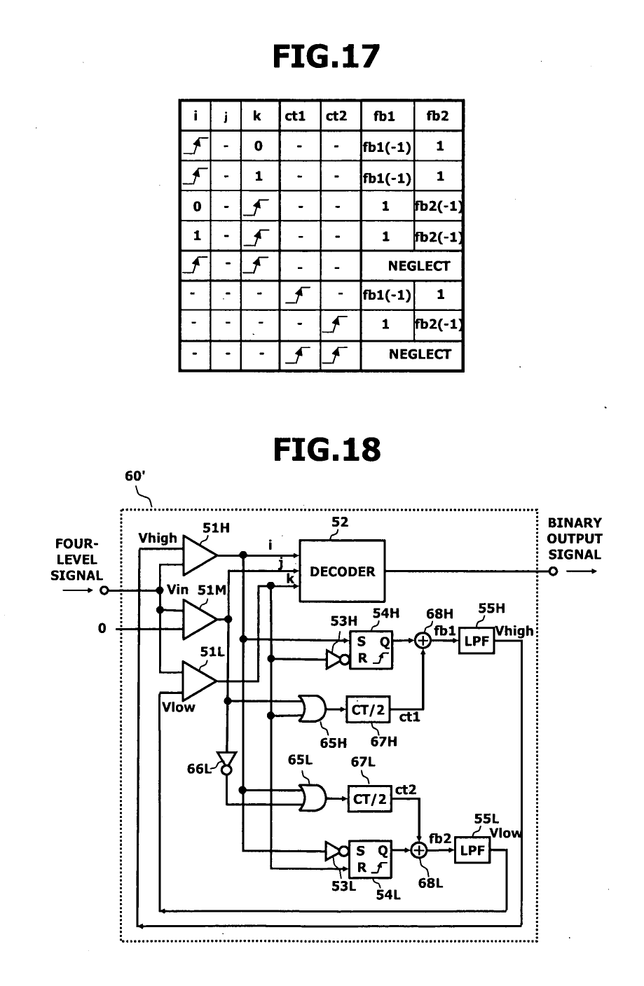

Also in the receiver 50 as described above, it is important that the feedback controls of the high level threshold voltage Vhigh and the low level threshold voltage Vlow are performed at high speeds according to a bit rate of the four-level signal. In the four-level signal such as the PAM4 or the like, as shown in FIG. 15, there are characteristics in that the change in V(j) is necessarily precedent to the changes in V(i) and V(k), and therefore, it is possible to sufficiently realize the high speed feedback controls capable of corresponding to 100 Gbps or the like.

As described in the above, according to the receiver 50 in the second embodiment, similarly to the first embodiment, it is possible to reduce a possibility that reception characteristics are varied by an influence of manufacturing process, temperature or the like, and it is also possible to reduce the power consumption. Further, differently from the conventional feedforward control, since the threshold voltages can be automatically regulated in real time without the necessity of an external signal, it becomes possible to extend the noise margin in the level judgment of the four-level input signal. Furthermore, since the configuration is such that the threshold voltages are optimized by the feedback controls, it is possible to realize the more stable reception characteristics relative to the temperature variation.

Next, there will be described a third embodiment of the multilevel signal receiver.

In the configuration of the second embodiment described above, one example has been described in which, in the level judgment of the four-level input signal, the threshold voltage (0[V]) of the comparator 51M which judges the intermediate level between +A/3[V] and −A/3[V] is not especially controlled. In this case, when a code change between +A/3[V] level and −A/3[V] level continues for a while, the respective high level and low level threshold voltages during the code change do not especially follow the change of the input signal at the intermediate level. Therefore, there is considered a possibility that an error occurs in the judgment of the change to +A/3[v] level or −A/3[v] level after the change at the intermediate level continues for a while. Consequently, in the third embodiment, there will be described an application example capable of performing the level judgment of the four-level input signal with high precision even if the change at the intermediate level continues for a while.

FIG. 16 is a block diagram showing a configuration of a receiver in the third embodiment.

In FIG. 16, a receiver 60 in the present embodiment is configured by adding inverters 61H and 61L, AND gates 62H and 62L, modulus-n counters (CT/n) 63H and 63L, and OR gates 64H and 64L, to the receiver 50 in the second embodiment shown in FIG. 8.

In the receiver 60, the output signal of the comparator 51M is supplied to one of input terminals of the AND gate 62H, and also, is supplied to one of input terminals of the AND gate 62L via the inverter 61L. To the other input terminal of the AND gate 62H, the output signal of the comparator 51H is input via the inverter 61H, and an output signal of the AND gate 62H is sent to the counter 63H. Further, to the other input terminal of the AND gate 62L, the output signal of the comparator 51L is input, and an output signal of the AND gate 62L is sent to the counter 63L. In the counter 63H and 63L, a logic value “1” of the output signals from the AND gates 62H and 62L is counted, and when the counting number reaches a previously set integer “n”, output signals ct1 and ct2 rise to 1 from 0. Namely, each of the counters 63H and 63L has a function of counting the repetition numbers of the intermediate level (+A/3[V] and −A/3[V]) for the four-level input signal. Then, the output signal of each of the counters 63H and 63L is supplied to one of input terminals of each of the OR gates 64H and 64L.

To the other input terminal of the OR gate 64H, the output signal of the comparator 51L is input, and an output signal of the OR gate 64H is supplied to the reset input terminal of the edge-triggered RS-FF 54H via the inverter 53H. Further, to the other input terminal of the OR gate 64L, the output signal of the comparator 51H is input, and an output signal of the OR gate 64L is supplied to the set input terminal of the edge-triggered RS-FF 54L via the inverter 53L. As a result, the signals of which voltage levels V (fb1) and V (fb2) are changed in accordance with the truth table shown in FIG. 7, are output from the edge-triggered RS-FFs 54H and 54L.

Accordingly, even if the change at the intermediate level continues for n-counting, since the high level and low level threshold voltages are regulated, it becomes possible to perform the level judgment of the four-level input signal with higher precision.

Next, there will be described a fourth embodiment of the multilevel signal receiver.

FIG. 18 is a block diagram showing a configuration of a receiver in the fourth embodiment.

In FIG. 18, a receiver 60′ in the fourth embodiment is a modified example of the receiver 60 in the third embodiment shown in FIG. 16, and herein, OR gates 65H and 65L, an inverter 66L, modulus-2 counters (CT/2) 67H and 67L, and adders 68H and 68L are combined to be used as a circuit configuration for counting the change at the intermediate level.

In the receiver 60′ the output signal of the comparator 51M is supplied to one of input terminals of the OR gate 65H, and also, is supplied to one of input terminals of the OR gate 65L via the inverter 66L. To the other input terminal of the OR gate 65H, the output signal of the comparator 51L is input, and an output signal of the OR gate 65H is sent to the counter 67H. Further, to the other input terminal of the OR gate 65L, the output signal of the comparator 51H is input, and an output signal of the OR gate 65L is sent to the counter 67L. In the counter 67H and 67L, a logic value “1” of the output signals from the AND gates 65H and 65L is counted, and when the counting number reaches 2, output signals ct1 and ct2 rise to 1 from 0. Then, an output signal of the counter 67H is supplied to an input terminal of the adder 68H inserted between the edge-triggered RS-FF 54H and the LPF 55H, and an output signal of the counter 67L is supplied to an input terminal of the adder 68L inserted between the edge-triggered RS-FF 54L and the LPF 55L. As a result, even if the change at the intermediate level (+A/3[V] and −A/3[V]) continues, since the high level and low level threshold voltages are regulated, it becomes possible to perform the level judgment of the four-level input signal with higher precision.

Next, there will be described a fifth embodiment of the multilevel signal receiver.

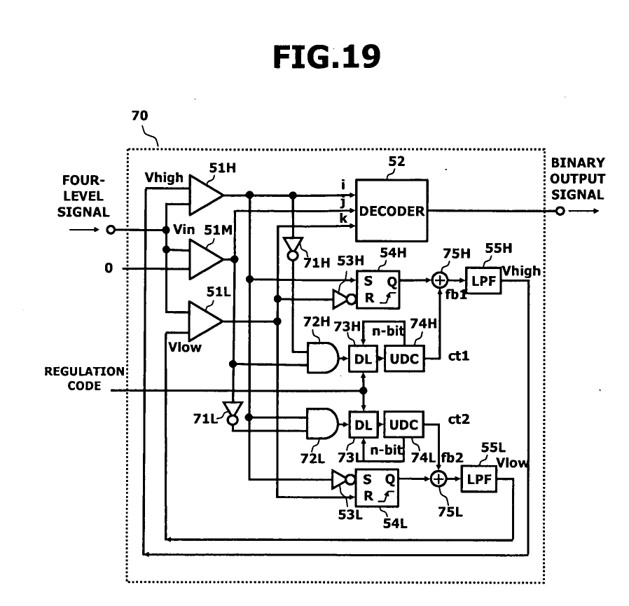

FIG. 19 is a block diagram showing a configuration of a receiver in the fifth embodiment.

In FIG. 19, a receiver 70 in the fifth embodiment is a modified example relating to the receiver 60 in the third embodiment shown in FIG. 16, and herein, inverters 71H and 71L, AND gates 72H and 72L, delay regulating circuits (DL) 73H and 73L, modulus-2 up-and-down counters (UDC) 74H and 74L, and adders 75H and 75L are combined to be used as a circuit configuration for counting the change at the intermediate level.

In the receiver 70, the output signal of the comparator 51M is supplied to one of input terminals of the AND gate 72H, and also, is supplied to one of input terminals of the AND gate 72L via the inverter 71L. To the other input terminal of the AND gate 72H, the output signal of the comparator 51H is input via the inverter 71H, and an output signal of the AND gate 72H is sent to the delay regulating circuit 73H. Further, to the other input terminal of the AND gate 72L, the output signal of the comparator 51H is input, and an output signal of the AND gate 72L is sent to the delay regulating circuit 73L. In each of the delay regulating circuits 73H and 73L, a delay time of the input signal is regulated in accordance with a regulating code supplied from outside and information supplied from each of the up-and-down counters 74H and 74L via a data path of n-bits. Output signals of the delay regulating circuits 73H and 73L are input respectively to the up-and-down counters 74H and 74L where changes of voltage levels of the output signals are counted, and when the counting number reaches 2, output signals ct1 and ct2 of the up-and-down counters 74H and 74L rise to 1 from 0. Then, an output signal of the up-and-down counter 74H is supplied to an input terminal of the adder 75H inserted between the edge-triggered RS-FF 54H and the LPF 55H, and an output signal of the up-and-down counter 74L is supplied to an input terminal of the adder 75L inserted between the edge-triggered RS-FF 54L and the LPF 55L. As a result, even if the change at the intermediate level (+A/3[V] and −A/3[V]) continues, since the high level and low level threshold voltages are regulated, it becomes possible to perform the level judgment of the four-level input signal with higher precision.

Next, there will be described a sixth embodiment of the multilevel signal receiver.

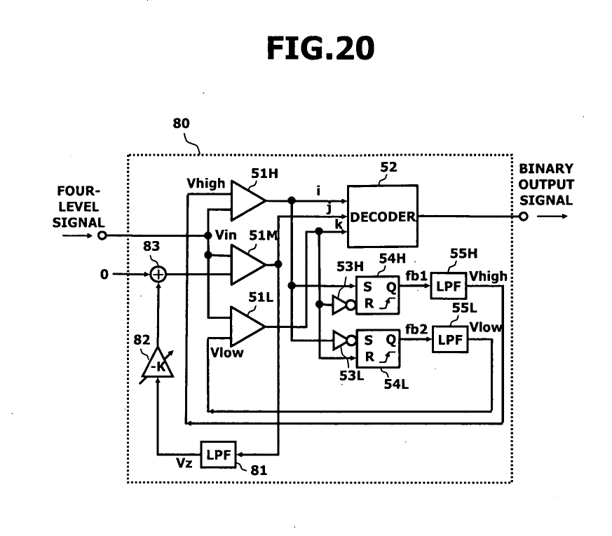

FIG. 20 is a block diagram showing a configuration of a receiver in the sixth embodiment.

In FIG. 20, a receiver 80 in the sixth embodiment is another application example of the receiver 50 in the second embodiment shown in FIG. 8, and herein, the output signal of the comparator 51M is supplied to a gain variable buffer 82 via a low-pass filter (LPF) 81, and an output voltage of the gain variably buffer 82 is added to a reference voltage (0[V]) supplied to the comparator 51M from outside.

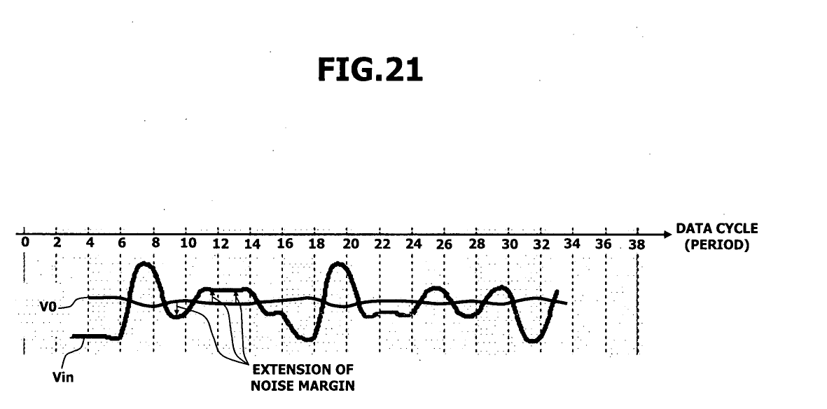

In the receiver 80, the output voltage V(j) of the comparator 51M passes through the LPF 81 to be integrated (averaged), and an output voltage “Vz” of the LPF 81 is supplied to the gain variable buffer 82 so that a signal of “−K·Vz” is output from the gain variable buffer 82. Then, the output signal of the gain variable buffer 82 is added to the reference voltage of O[V] in the adder 83, so that the threshold voltage V0 of 0 level follows the change at the intermediate level (+A/3[V] and −A/3[V]) of the four-level signal Vin to be regulated as shown in FIG. 21, and the noise margin in the level judgment is extended, and consequently, it becomes possible to perform the level judgment of the input signal with higher precision.

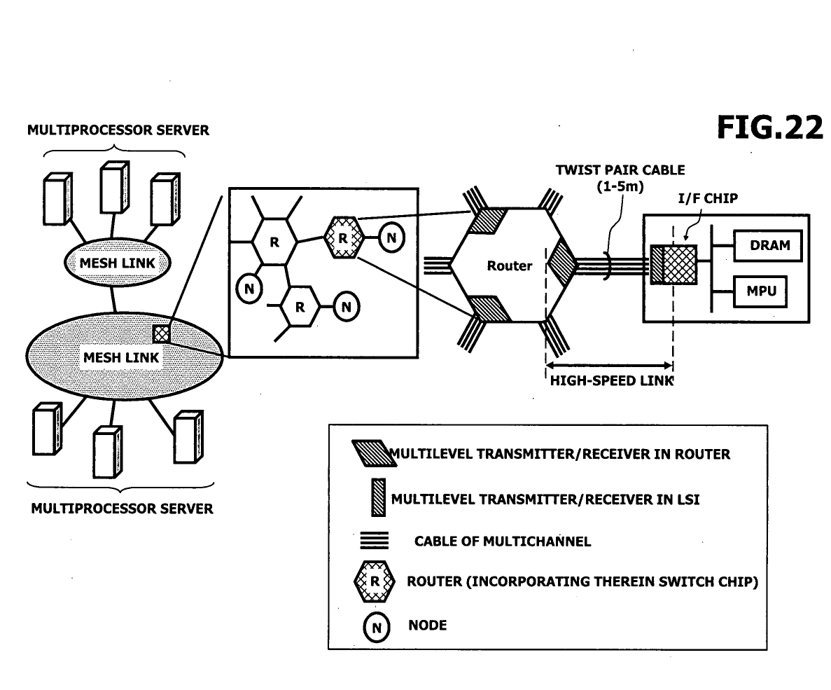

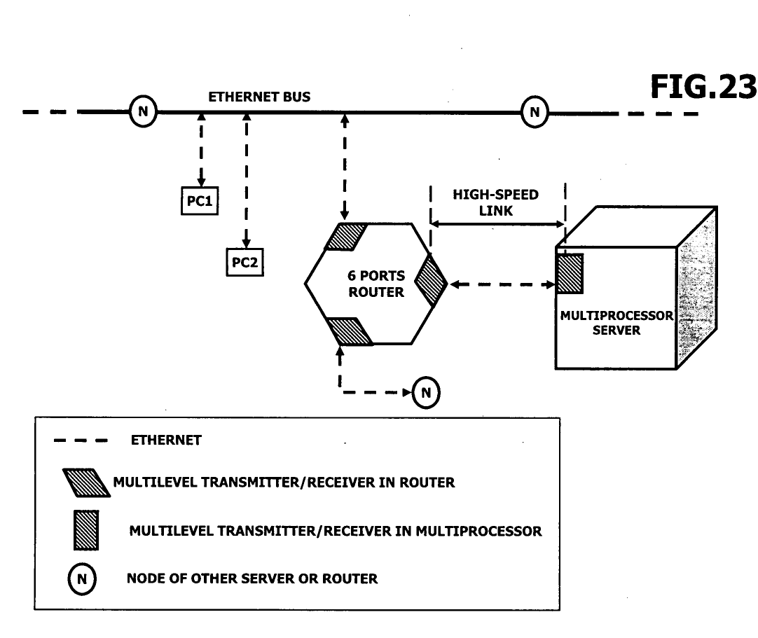

The multilevel signal receiver in each of the first to sixth embodiments as described above is suitable to be used as a serializer/deserializer circuit, a multiplexer or a demultiplexer for the 100 Gbps Ethernet, and also, is available for a high power transceiver system. FIG. 22 is one example in which the present multilevel signal receiver is applied to a server network. In this server network, a plurality of multi-processer servers is connected to a mesh link, and the mesh link includes a large number of routers and a large number of nodes, to configure a local area network (LAN) or a wide area network (WAN). Further, each router incorporates therein a switch chip, and to respective multilevel transmitter/receivers in the router, multichannel cables each using a twist cable of the length of 1 to 5 meters (m) are connected. To the tip of each multichannel cable, a microprocessor (MPU), a DRAM and the like are connected via an interface (I/F) chip. In such a server network, the present multilevel signal receiver can be used as a receiver of a high-speed interface circuit which transmits data between the I/F chip and the router. As a result, it becomes possible to reduce the data concentration, and also, to reduce the number of disposed network adapters, the number of cables and the number of switches in the router. Further, FIG. 23 is one example in which the present multilevel signal receiver is applied to a local area network (LAN). To this LAN, a plurality of nodes each including a multiprocessor server, a router, a personal computer (PC) and the like, is connected via an Ethernet bus, and the present multilevel signal receiver can be used as a receiver of a high-speed interface circuit which transmits data between a multilevel transmitter/receiver in the multiprocessor server and that in the router.

Incidentally, application examples of the present multilevel signal receiver are not limited to the above, and, the present multilevel signal receiver is applicable to an interface circuit of a memory, a hard disk or the like, for example. Further, the bit rate of the multilevel signal is not limited to 100 Gbps, and the present multilevel signal receiver can cope with a wide bit rate, such as, 10 Gbps, 40 Gbps, 80 Gbps, 120 Gbps or the like, for example.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A multilevel signal receiver which is input with a multilevel signal amplitude modulated into three or more levels, judges levels of the input signal using at least two thresholds and outputs a signal converted into binary in accordance with the level judgment results, comprising:
a first judging section that is input with the multilevel signal and a signal indicating a first threshold, and judges whether or not the levels of the multilevel signal are higher than the first threshold, to output a signal of which level is changed in accordance with the judgment result;
a second judging section that is input with the multilevel signal and a signal indicating a second threshold of which level is lower than that of the first threshold, and judges whether or not the levels of the multilevel signal are lower than the second threshold, to output a signal of which level is changed in accordance with the judgment result;
a first feedback control section that uses the output signal of the first judging section and a signal obtained by inverting the output signal of the second judging section, and, according to appearance timing of leading edges of the respective signals, regulates the level of the first threshold supplied to the first judging section;
a second feedback control section that uses the output signal of the second
a converting section that outputs a binary signal converted from the multilevel signal, in accordance with the output signals of the first and second judging sections.

2. A multilevel signal receiver according to claim 1,
wherein the first judging section includes a first comparator which outputs a signal indicating a logic value “1” when the levels of the multilevel signal are higher than the first threshold, while indicating “0” at the rest time;
the second judging section includes a second comparator which outputs a signal indicating a logic value “1” when the levels of the multilevel signal are lower than the second threshold, while indicating “0” at the rest time;
the first feedback control section includes: a first edge-triggered RS flip-flop which is input with the output signal of the first comparator at an input terminal on the set side thereof and a signal obtained by inverting an output signal of the second comparator at an input terminal on the reset side thereof; and a first low-pass filter which is input with an output signal of the first edge-triggered RS flip-flop, and feeds back an output signal of the first low-pass filter to the first comparator as the signal indicating the first threshold; and
the second feedback control section includes: a second edge-triggered RS flip-flop which receives a signal obtained by inverting the output signal of the first comparator at an input terminal on the set side thereof and the output signal of the second comparator at an input terminal on the reset side thereof; and a second low-pass filter which is input with an output signal of the second edge-triggered RS flip-flop, and feeds back an output signal of the second low-pass filter to the second comparator as the signal indicating the second threshold.

3. A multilevel signal receiver according to claim 1,
wherein the multilevel signal is a three-level signal amplitude modulated into high-level, 0-level and low-level;
the first judging section judges the high-level of the three-level signal, on the basis of the first threshold regulated at an intermediate between the high-level of the three-level signal and the 0-level thereof by the first feedback control section; and
the second judging section judges the low-level of the three-level signal, on the basis of the second threshold regulated at an intermediate between the low-level of the three-level signal and the 0-level thereof by the second feedback control section.

4. A multilevel signal receiver according to claim 3,
wherein the multilevel signal is a duo-binary signal.

5. A multilevel signal receiver according to claim 1,
wherein the multilevel signal is a four-level signal amplitude modulated into A-level, A/3-level, −A/3-level and −A-level provided that the maximum voltage amplitude is 2 A;
there is provided a third judging section that is input with the four-level signal and a signal indicating a third threshold of which level is lower than that of the first threshold but is higher than that of the second threshold, and judges whether levels of the four-level signal are higher or lower than the third threshold, to output a signal of which level is changed in accordance with the judgment result;
the first judging section judges the A-level of the four-level signal, on the basis of the first threshold regulated at an intermediate between the A-level of the four-level signal and the A/3-level thereof by the first feedback control section;
the second judging section judges the −A-level of the four-level signal, on the basis of the second threshold regulated at an intermediate between the −A-level of the four-level signal and the −A/3-level thereof by the second feedback control section; and
the converting section outputs a binary signal converted from the four-level signal, in accordance with the output signals of the first to third judging sections.

6. A multilevel signal receiver according to claim 5, further comprising;
an intermediate level continuous detecting section that detects a state where a level change of the four-level signal is kept between the A/3-level and the −A/3-level, based on the output signal of the third judging section,
wherein the first and second feedback control sections regulate respectively the levels of the first and second thresholds, according to the detection result of the intermediate level continuous detecting section.

7. The multilevel signal receiver according to claim 6,
wherein the intermediate level continuous detecting section includes: a first AND gate which is input with the output signal of the third judging section and a signal obtained by inverting the output signal of the first judging section; a first counter which counts a logic value “1” of an output signal of the first AND gate, and of which output signal level is changed when the counting number reaches a predetermined value; a second AND gate which is input with the output signal of the second judging section and a signal obtained by inverting the output signal of the third judging section; and a second counter which counts a logic value “1” of an output signal of the second AND gate, and of which output signal level is changed when the counting number reaches a predetermined value,
the first feedback control section includes: a first OR gate which is input with the output signal of the first counter and the output signal of the second judging section; a first edge-triggered RS flip-flop which is input with the output signal of the first judging section at an input terminal on the set side thereof and a signal obtained by inverting an output signal of the first OR gate at an input terminal on the reset side thereof; and a first low-pass filter which is input with an output signal of the first edge-triggered RS flip-flop, and feeds back an output signal of the first low-pass filter to the first judging section as the signal indicating the first threshold, and
the second feedback control section includes: a second OR gate which is input with the output signal of the second counter and the output signal of the first judging section; a second edge-triggered RS flip-flop which is input with the output signal of the second judging section at an input terminal on the reset side thereof and a signal obtained by inverting an output signal of the second OR gate at an input terminal on the set side thereof; and a second low-pass filter which is input with an output signal of the second edge-triggered RS flip-flop, and feeds back an output signal of the second low-pass filter to the second judging section as the signal indicating the second threshold.

8. A multilevel signal receiver according to claim 6,
wherein the intermediate level continuous detecting section includes: a first OR gate which is input with the output signal of the third judging section and the output signal of the second judging section; a first counter which counts a logic value “1” of an output signal of the first OR gate, and of which output signal level is changed when the counting number reaches 2; a second OR gate which is input with the output signal of the first judging section and a signal obtained by inverting the output signal of the third judging section; and a second counter which counts a logic value “1” of an output signal of the second OR gate, and of which output signal level is changed when the counting number reaches 2,
the first feedback control section includes: a first edge-triggered RS flip-flop which is input with the output signal of the first judging section at an input terminal at the set side thereof and a signal obtained by inverting the output signal of the second judging section at an input terminal on the reset side thereof; a first adder which adds an output signal of the first edge-triggered RS flip-flop and the output signal of the first counter; and a first low-pass filter which is input with an output signal of the first adder, and feeds back an output signal of the first low-pass filter to the first judging section as the signal indicating the first threshold, and
the second feedback control section includes: a second edge-triggered RS flip-flop which is input with the output signal of the second judging section at an input terminal on the reset side thereof and a signal obtained by inverting the output signal of the first judging section at an input terminal on the set side thereof; a second adder which adds an output signal of the second edge-triggered RS flip-flop and the output signal of the second counter; and a second low-pass filter which is input with an output signal of the second adder, and feeds back an output signal of the second low-pass filter to the second judging section as the signal indicating the second threshold.

9. A multilevel signal receiver according to claim 6,
wherein the intermediate level continuous detecting section includes: a first AND gate which is input with the output signal of the third judging section and a signal obtained by inverting the output signal of the first judging section; a first delay regulating circuit which regulates a delay time in an output signal of the first AND gate; a first up-and-down counter which counts a level change in an output signal of the first delay regulating circuit, and of which output signal level is changed when the counting number reaches 2; a second AND gate which is input with the output signal of the first judging section and a signal obtained by inverting the output signal of the third judging section; a second delay regulating circuit which regulates a delay time in an output signal of the second AND gate; and a second up-and-down counter which counts a level change in an output signal of the second delay regulating circuit, and of which output signal level is changed when the counting number reaches 2,
the first feedback control section includes: a first edge-triggered RS flip-flop which is input with the output signal of the first judging section at an input terminal on the set side thereof and a signal obtained by inverting the output signal of the second judging section at an input terminal on the reset side thereof; a first adder which adds an output signal of the first edge-triggered RS flip-flop and the output signal of the first up-and-down counter; and a first low-pass filter which is input with an output signal of the first adder, and feeds back an output signal of the first low-pass filter to the first judging section as the signal indicating the first threshold; and
the second feedback control section includes: a second edge-triggered RS flip-flop which input with the output signal of the second judging section at an input terminal on the reset side thereof and a signal obtained by inverting the output signal of the first judging section at an input terminal on the set side thereof; a second adder which adds an output signal of the second edge-triggered RS flip-flop and the output signal of the second up-and-down counter; and a second low-pass filter which is input with an output signal of the second adder, and feeds back an output signal of the second low-pass filter to the second judging section as the signal indicating the second threshold.

10. A multilevel signal receiver according to claim 5, further comprising;
a third feedback control section that regulates the level of the third threshold input to the third judging section, according to the output signal of the third judging section.

11. A multilevel signal receiver according to claim 10,
wherein the third feedback control section includes: a low-pass filter which is input with the output signal of the third judging section; a buffer which amplifies an output signal of the low-pass filter by a variable gain to output it; and an adder which adds an output voltage of the buffer to the third threshold.

12. A multilevel signal receiver according to claim 5,
wherein the multilevel signal is a four-level pulse-amplitude modulation (PAM4) signal.

13. A multilevel signal receiver according to claim 5,
wherein the multilevel signal is a partial response (PR4) signal.

14. An interface circuit comprising: a transmitter which encodes a binary signal to generate a multilevel signal amplitude modified into three or four levels, to thereby transmit the multilevel signal to a transmission path; and a receiver which decodes the multilevel signal propagated through the transmission path, to generate a binary signal,
wherein a multilevel signal receiver recited in claim 1 is used as the receiver.
